(19) United States
(12) Patent Application Publication
(10) Pub. No.: US 2015/0089132 A1
(43) Pub. Date: Mar. 26, 2015

(54) DYNAMIC STORAGE VOLUME CONFIGURATION BASED ON INPUT/OUTPUT REQUESTS

(71) Applicant: LSI CORPORATION, San Jose, CA (US)

(72) Inventors: Naresh Madhusudana, Bangalore (IN); Naveen Krishnamurthy, Bangalore (IN)

(73) Assignee: LSI CORPORATION, San Jose, CA (US)

(21) Appl. No.: 14/173,561

(22) Filed: Feb. 5, 2014

(30) Foreign Application Priority Data
Sep. 23, 2013 (IN) 4308/CHE/2013

(51) Int. Cl. G06F 3/06

(52) U.S. Cl. CPC G06F 3/0665; G06F 3/0689; G06F 3/0619
USPC 711/114

(57) ABSTRACT

A storage system includes a plurality hard disk drives and a plurality of solid-state drives and a storage controller operable to manage the hard disk drives and solid-state drives as a plurality of logical volumes, and categorize input/output requests to the logical volumes into types based on sizes of the input/output requests (e.g., smaller and larger). The storage controller is also operable to reconfigure the logical volumes from the hard disk drives and the solid-state drives based on the types of the input/output requests to the logical volumes. A first of the reconfigured logical volumes occupies a first portion of at least one of the solid-state drives and a first portion of at least one of the hard disk drives. The storage controller is further operable to direct the first type of the input/output requests to the first portion of the solid-state drive occupied by the first reconfigured logical volume.

This document claims priority to Indian Patent Application No. 4308/CHE/2013 (filed on Sep. 23, 2013) entitled DYNAMIC STORAGE VOLUME CONFIGURATION BASED ON INPUT/OUTPUT REQUESTS, which is hereby incorporated by reference.

### FIELD OF THE INVENTION

The invention generally relates to field of storage system optimization.

### BACKGROUND

Storage systems create storage volumes from storage devices, such as the hard disk drives (HDDs) and solid-state drives (SSDs), to store and manage data. The storage systems process input/output (I/O) requests with one or more storage controllers to direct data to and from the storage volumes. The size and the configuration of the storage volumes are generally static, regardless of the type or size of the I/O request. Thus, there is no assurance where I/O requests are to be written. For example, in a server based storage system, the server may generate I/Os containing large chunks of continuous data as well as smaller/random “burst-like” I/Os. When the logical volumes are statically configured from SSDs and HDDs, the storage system endures latency because there is no way to distinguish between the faster albeit costlier SSDs from the higher density HDDs.

### SUMMARY

Systems and methods presented herein provide for optimizing storage space of logical volumes based on I/O requests. In one embodiment, a storage system includes a plurality HDDs and a plurality of SDDs and a storage controller operable to manage the HDDs and SDDs as a plurality of logical volumes, and categorize input/output requests to the logical volumes into types based on sizes of the input/output requests (e.g., smaller and larger). The storage controller is also operable to reconfigure the logical volumes from the HDDs and the SDDs based on the types of the input/output requests to the logical volumes. A first of the reconfigured logical volumes occupies a first portion of at least one of the SDDs and a first portion of at least one of the HDDs. The storage controller is further operable to direct the first type of the input/output requests to the first portion of the SDD occupied by the first reconfigured logical volume.

The various embodiments disclosed herein may be implemented in a variety of ways as a matter of design choice. For example, the embodiments may take the form of computer hardware, software, firmware, or combinations thereof. Other exemplary embodiments are described below.

### BRIEF DESCRIPTION OF THE FIGURES

Some embodiments of the present invention are now described, by way of example only, and with reference to the accompanying drawings. The same reference number represents the same element or the same type of element on all drawings.

FIGS. 1 and 2 are block diagrams of an exemplary storage system comprising a plurality of storage devices.

FIG. 3 is a flowchart of an exemplary process of the storage system of FIG. 1.

FIGS. 4-6 are block diagrams of an exemplary storage system creating and optimizing logical volumes based on I/O requests.

FIG. 7 is a block diagram of an exemplary computing system in which a computer readable medium provides instructions for performing methods herein.

### DETAILED DESCRIPTION OF THE FIGURES

The figures and the following description illustrate specific exemplary embodiments of the invention. It will thus be appreciated that those skilled in the art will be able to devise various arrangements that, although not explicitly described or shown herein, embody the principles of the invention and are included within the scope of the invention. Furthermore, any examples described herein are intended to aid in understanding the principles of the invention and are to be construed as being without limitation to such specifically recited examples and conditions. As a result, the invention is not limited to the specific embodiments or examples described below.

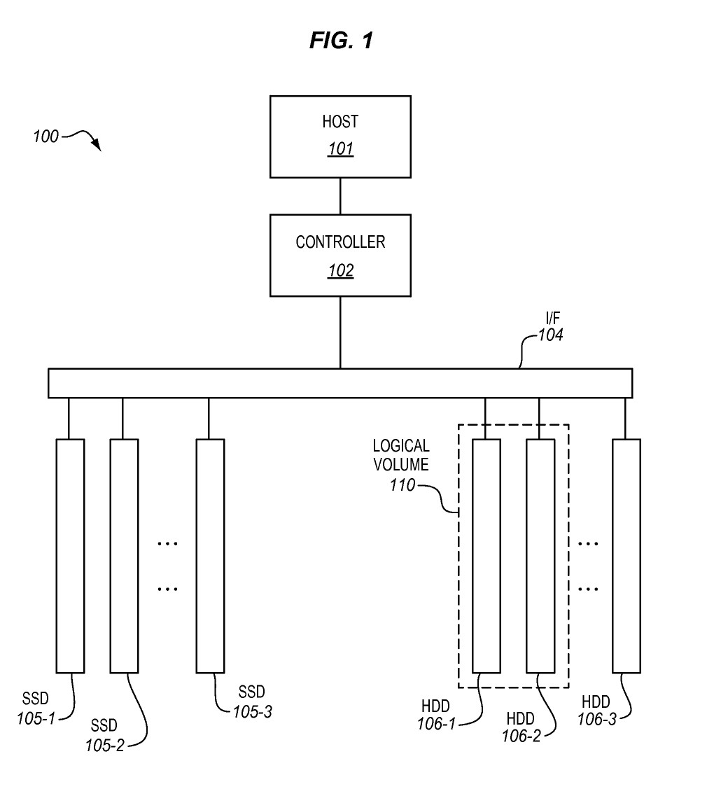

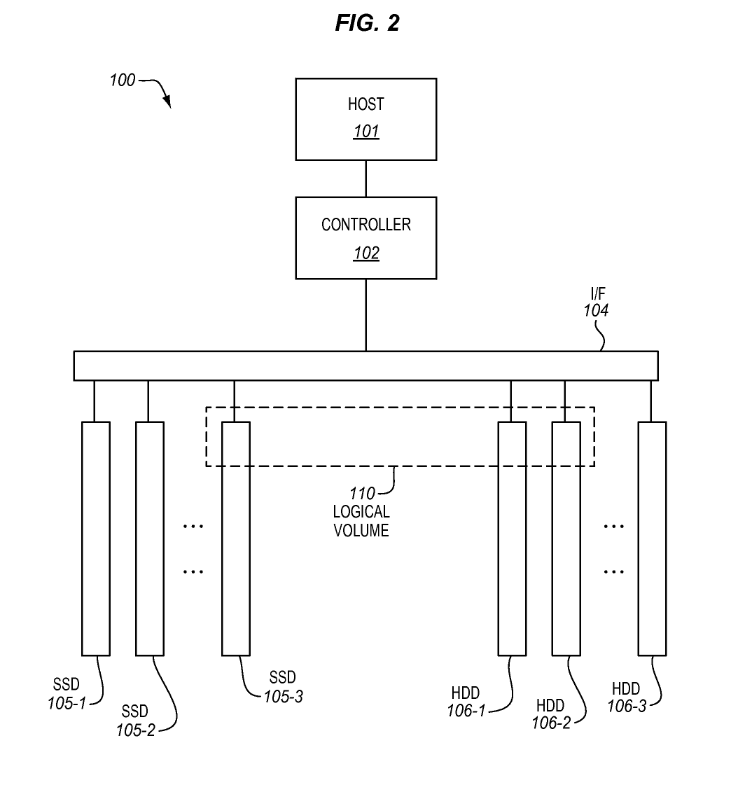

FIGS. 1 and 2 are block diagrams of an exemplary storage system 100 comprising a plurality of SSDs 105-1-105-3 and a plurality of HDDs 106-1-106-3. The storage system 100 is configured with a controller 102 that is operable to receive and process I/O requests from a host 101 to the various drives 105 and 106. The controller 102 is also operable to analyze the incoming I/O requests from the host 101 and to categorize them into types which may be used to dynamically allocate/configure the logical volume 110 according to those types. For example, the controller 102 may configure the logical volume 110 from the HDDs 106-1-106-2 to accommodate a variety of I/O requests, as illustrated in FIG. 1. After analyzing the I/O requests directed to the logical volume 110, the controller 102 may determine that certain I/O requests, such as short “burst like” I/O requests and random I/O requests, to the logical volume 110 may be better handled by one or more of the SSDs 105-1-105-3. Accordingly, the controller 102 may reconfigure the logical volume 110 to occupy at least a portion of one of the SSDs 105, as illustrated in FIG. 2 with the logical volume 110 occupying a portion of the SSD 105-3.

The controller 102 is any system, device, software, or combination thereof operable to process I/O requests to the drives 105 and 106 and dynamically optimize configurations of the logical volume 110 from various combinations of the drives 105 and 106 based on the I/O requests. The controller 102 may be configured within the host 101 (e.g., as a host bus adapter) or as a separate storage controller. The controller 102 may be used to also implement various forms of Redundant Array of Independent Disks (RAID) methodologies with the logical volume 110.

The storage system 100 may also include an interface 104 operable to communicatively couple the drives 105 and 106 to the controller 102. For example, the interface 104 may be a switched fabric, such as that found in a Serial Attached Small Computer System Interface (SAS) topology employing SAS expanders and other SAS and/or Peripheral Computer Interface (PCI) devices.

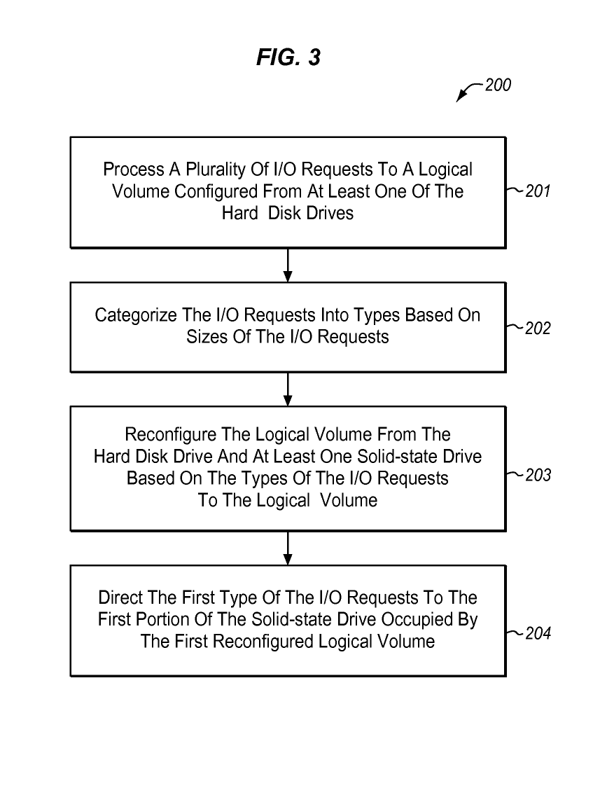

Although shown and described with respect to a certain number of SSDs 105, HDDs 106, and logical volumes 110, the invention is not intended to be limited to the exemplary drawing. Those skilled in the art would readily recognize that the storage system 100 may be configured in a variety of ways with a variety of different devices to implement the inventive concepts described herein. Discussion of the storage system 100 will now be directed to the flowchart 200 of FIG. 3 to illustrate the concepts shown in FIGS. 1 and 2.

FIG. 3 is a flowchart of an exemplary process of the storage system 100. In this embodiment, it is presumed that the storage system 100 is implemented with a static logical volume 110 configured from the HDDs 106-1 and 106-2 and that the controller 102 is processing I/O requests to the logical volume 110 on behalf of the host 101, in the process element 201. As each I/O request comes in, the controller 102 categorizes the I/O requests into types based on sizes of the I/O requests, in the process element 202. For example, some I/O requests have relatively little data and/or are somewhat random in nature, such as I/O requests relating to machine and operating system functionality. Other I/O requests are more specific to writing relatively large continuous/sequential chunks of data to the logical volume 110. The controller 102 categorizes these I/O requests as they come in according to the sizes of the data contained therein.

After processing multiple I/O requests to the logical volume 110, the controller reconfigures the logical volume 110 based on the types of the I/O requests to the logical volume 110, in the process element 203. That is, the controller 102 analyzes the I/O requests to the logical volume 110 occupying the HDDs 106-1 and 106-2 in this example. The controller 102 determines that some of the I/O requests (e.g., the smaller/random I/O requests) could be better handled by the SSDs 105. The controller 102 then reconfigures the logical volume 110 to occupy at least a portion of one or more of the SSDs 105 to accommodate those I/O requests, as shown by the SSD 105-3 in FIG. 2.

In reconfiguring the logical volume 110, the controller 102 may analyze the storage space requirements for the logical volume 110 to determine how much storage space of the HDDs 106 is still required by the logical volume 110. Thus, the controller 102 may use some portion of the allocated storage space of the HDDs 106-1 and 106-2, as shown in this example in FIG. 2, or all of the previously allocated storage space of the HDDs 106-1 and 106-2. The controller 102 may even allocate additional space in other HDDs 106, such as the HDD 106-3 based on the I/O requests.

With the logical volume 110 reconfigured, the controller 102 then directs the I/O requests to the logical volume 110 that are better suited for the SSDs 105 to the allocated space of the SSD 105-3 as illustrated in FIG. 2, in the process element 204. The remaining I/O requests (e.g., the larger I/O requests) are then directed to the storage space allocated in the HDDs 106-1 and 106-2.

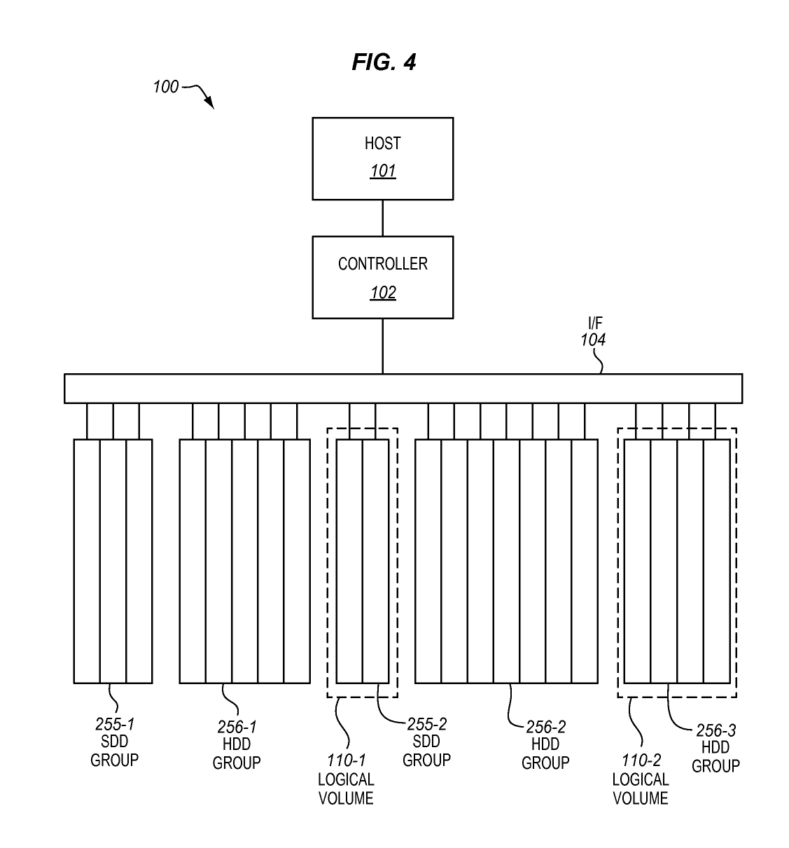

FIGS. 4-6 are block diagrams of the storage system 100 exemplarily creating and optimizing logical volumes 110 based on I/O requests. In this embodiment, the storage system 100 is configured with SSD groups 255-1 and 255-2 and HDD groups 256-1-256-3, the groups being configured with various numbers of SSD or HDD drives (e.g., SSD group 255-1 has three SSDs, HDD group 256-1 has five HDDs, etc.). FIG. 4 illustrates the storage system 100 initially configured with static logical volumes 110-1 configured from the SSD group 255-2 and 110-2 configured from the HDD group 256-3.

After the logical volumes 110-1 and 110-2 are configured, the controller 102 manages the logical volumes 110-1 and 110-2 and processes I/O requests from the host 101 to the logical volumes 110-1 and 110-2. In processing I/O requests to the logical volumes 110-1 and 110-2, the controller 102 analyzes the types of I/O requests, the sizes of the I/O requests (e.g., the size of the data in the request), and/or frequencies of certain types of I/O requests. For example, the controller 102 may receive a write I/O request and extract the data associated with the I/O request and thus determine the size of the data to be stored in the logical volume 110-2. The controller 102 may then write the data of the I/O request to one or more of the HDDs of the HDD group 256-3 that make up the logical volume 110-2. Over time, the controller 102 compiles statistical information of the I/O requests to the logical volume 110-2 such that the controller 102 can optimize I/O requests to the logical volume 110-2 by dynamically allocating space on other drive groups 255 and 256.

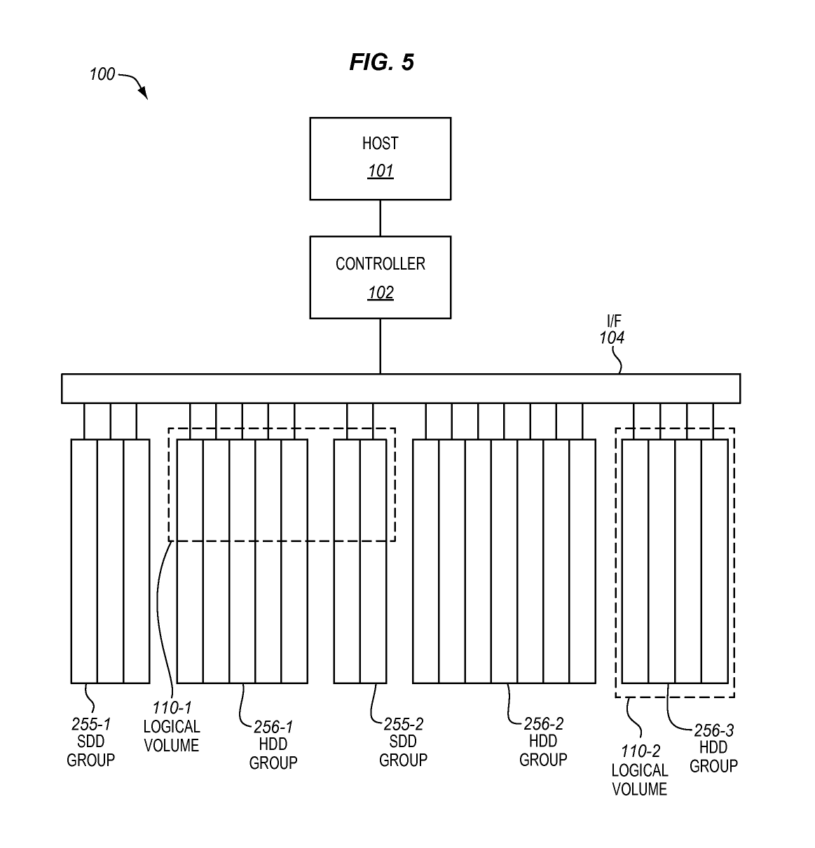

FIG. 5 illustrates an exemplary reallocation of drive groups 255 and 256 for the logical volume 110-1. In this example, the controller 102 analyzes the I/O requests to the logical volume 110-1 existing on the SSD group 255-2, as illustrated in FIG. 4. The controller 102, in FIG. 5, then determines that a certain number of the I/O requests have large chunks of continuous/sequential data that would not encounter latency issues if written to HDDs. Accordingly, the controller 102 allocates a portion of space in the HDD group 256-1 based on the larger I/O requests. The controller 102 may also determine that the space requirements for the smaller/more frequent I/O requests to the SSD group 255-2 no longer require as much storage capacity. Accordingly, the controller 102 reduces the storage space for the logical volume 110-1 such that it occupies a lesser portion of the SSD group 255-2.

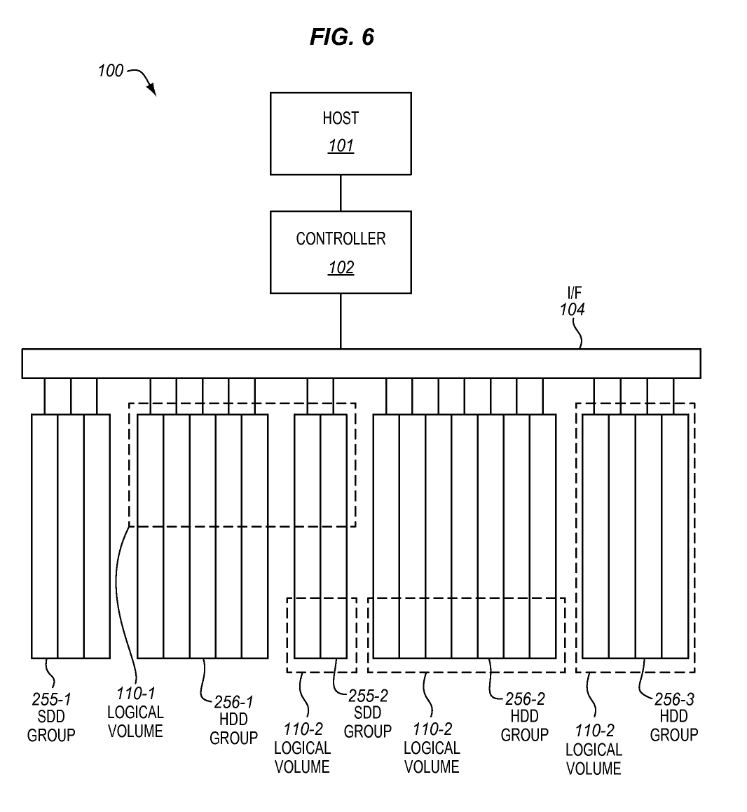

In FIG. 6, the controller 102 determines that the logical volume 110-2 is increasingly experiencing a larger number of I/O requests with larger continuous/sequential data. Accordingly, the controller 102 allocates a portion of the HDD group 256-2 to the logical volume 110-2 in addition to allocating a portion of the SSD group 255-2 to the logical volume 110-2 for the smaller burst like I/O requests.

Again, the invention is not intended to be limited to any particular type of logical volume optimization and/or creation. The embodiments presented herein reserve a total volume space from an available drive pool of HDDs and SSDs. Subsequently, in the context of an I/O, the controller 102 analyzes the I/O pattern and allocates blocks dynamically from the drive pool, either from HDDs/SSDs. In some instances, the controller 102 analyzes the incoming I/O requests to the logical volumes using statistical analysis and/or mathematical optimization techniques. In any case, the inventive concepts herein provide optimal I/O performance and deterministic latency for different I/O request types and provide dynamic allocation of storage space depending on the I/O requests.

Additionally, the dynamic allocation features herein pertaining to logical volumes can be flexibly configured such that the controller 102 can revert back to its original static logical volume configurations. For example, the controller 102 may retain a map of the data for previous logical volumes that were statically created. The controller 102 may compare the map for the static logical volumes to the reconfigured logical volumes to restore the logical volumes to their previous drive groups 255 and 256 upgraded with the newer data of the reconfigured logical volumes. Thus, the controller 102 can reconfigure a logical volume into a homogeneous array of HDDs and/or a homogeneous array SDDs after configuring the logical volume from a heterogeneous array of HDDs and SDDs.

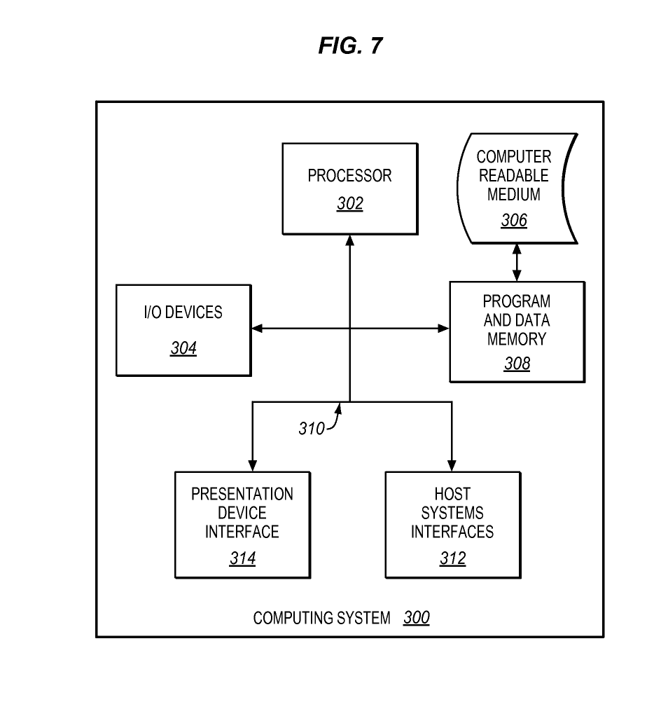

The invention can take the form of an entirely hardware embodiment, an entirely software embodiment or an embodiment containing both hardware and software elements. In one embodiment, the invention is implemented in software, which includes but is not limited to firmware, resident software, microcode, etc. FIG. 7 illustrates a computing system 300 in which a computer readable medium 306 may provide instructions for performing any of the methods disclosed herein.

Furthermore, the invention can take the form of a computer program product accessible from the computer readable medium 306 providing program code for use by or in connection with a computer or any instruction execution system. For the purposes of this description, the computer readable medium 306 can be any apparatus that can tangibly store the program for use by or in connection with the instruction execution system, apparatus, or device, including the computer system 300.

The medium 306 can be any tangible electronic, magnetic, optical, electromagnetic, infrared, or semiconductor system (or apparatus or device). Examples of a computer readable medium 306 include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

The computing system 300, being suitable for storing and/or executing program code, can include one or more processors 302 coupled directly or indirectly to memory 308 through a system bus 310. The memory 308 can include local memory employed during actual execution of the program code, bulk storage, and cache memories which provide temporary storage of at least some program code in order to reduce the number of times code is retrieved from bulk storage during execution. I/O devices 304 (including but not limited to keyboards, displays, pointing devices, etc.) can be coupled to the system either directly or through intervening I/O controllers. Network adapters may also be coupled to the system to enable the computing system 300 to become coupled to other data processing systems, such as through host systems interfaces 312, or remote printers or storage devices through intervening private or public networks. Modems, cable modem and Ethernet cards are just a few of the currently available types of network adapters.

What is claimed is:

1. A storage system, comprising:
a plurality hard disk drives and a plurality of solid-state drives, each of which being operable to store data; and
a storage controller operable to:
manage the hard disk drives and solid-state drives as a plurality of logical volumes;
process a plurality of input/output requests to the logical volumes;
categorize the input/output requests into types based on sizes of the input/output requests, wherein a first type of the input/output requests has a size that is smaller than a second type of the input/output requests; and
reconfigure the logical volumes from the hard disk drives and the solid-state drives based on the types of the input/output requests to the logical volumes,
wherein a first of the reconfigured logical volumes occupies a first portion of at least one of the solid-state drives and a first portion of at least one of the hard disk drives, and
wherein the storage controller is further operable to direct the first type of the input/output requests to the first portion of said at least one of the solid-state drives occupied by the first reconfigured logical volume.

2. The storage system of claim 1, wherein the storage controller is further operable to:
identify an input/output request to a second logical volume;
determine that the input/output request to the second logical volume is the second type of the input output requests;
determine that the second logical volume is configured without hard disk drives;
identify a hard disk drive from the plurality of hard disk drives to allocate space for the second logical volume; and
direct the input/output request to the hard disk drive with the allocated space for the second logical volume.

3. The storage system of claim 1, wherein the storage controller is further operable to:
analyze storage space of the hard disk drives and of the solid-state drives to identify said at least one of the solid-state drives to direct the first type of the input/output requests to the first reconfigured logical volume.

4. The storage system of claim 1, wherein the storage controller is further operable to:
reconfigure the first logical volume to a homogeneous array of hard disk drives or solid-state drives after configuring the first logical volume from a heterogeneous array of hard disk drives and solid-state drives.

5. The storage system of claim 1, wherein the storage controller is further operable to:
analyze frequency of the smaller input/output requests to configure at least one storage volume from a combination of solid state drives and hard disk drives.

6. The storage system of claim 1, wherein the storage controller is further operable to:
reconfigure a second logical volume from at least one of the solid state drives into a combination of solid state drives and hard disk drives.

7. The storage system of claim 1, being a Redundant Array of Independent Disks storage system.

8. A method operable in the storage system comprising a plurality hard disk drives and a plurality of solid-state drives, each of which being operable to store data, the method comprising:
processing a plurality of input/output requests to a logical volume configured from at least one of the hard disk drives;
categorizing the input/output requests into types based on sizes of the input/output requests, wherein a first type of the input/output requests has a size that is smaller than a second type of the input/output requests;
reconfiguring the logical volume from the at least one hard disk drive and at least one solid-state drive based on the types of the input/output requests to the logical volume,
wherein the reconfigured logical volume occupies a first portion of the at least one solid-state drive and a first portion of the at least one hard disk drive; and
directing the first type of the input/output requests to the first portion of the at least one solid-state drive occupied by the first reconfigured logical volume.

9. The method of claim 8, further comprising:
identifying an input/output request to another logical volume;
determining that the input/output request to the other logical volume is the second type of the input output requests;
determining that the other logical volume is configured without hard disk drives;
identifying a hard disk drive from the plurality of our disk drives to allocate space for the other logical volume; and
directing the input/output request to the hard disk drive with the allocated space for the other logical volume.

10. The method of claim 8, further comprising:
analyzing storage space of the hard disk drive and of the solid-state drives to identify said at least one of the solid-state drives to direct the first type of the input/output requests to the first reconfigured logical volume.

11. The method of claim 8, further comprising:
reconfiguring the first logical volume to a homogeneous array of hard disk drives or solid-state drives after configuring the first logical volume from a heterogeneous array of hard disk drives and solid-state drives.

12. The method of claim 8, further comprising:
analyzing frequency of the smaller input/output requests to configure at least one storage volume from a combination of solid state drives and hard disk drives.

13. The method of claim 8, further comprising:
reconfiguring another logical volume from at least one of the solid state drives into a combination of solid state drives and hard disk drives.

14. The method of claim 8, being operable in a Redundant Array of Independent Disks storage system.

15. A non-transitory computer readable medium comprising instructions that, when executed in a storage system comprising a plurality hard disk drives and a plurality of solid-state drives, each of which being operable to store data, direct a storage controller of the storage system to:
process a plurality of input/output requests to a logical volume configured from at least one of the hard disk drives;
categorize the input/output requests into types based on sizes of the input/output requests, wherein a first type of the input/output requests has a size that is smaller than a second type of the input/output requests;
reconfigure the logical volume from the at least one hard disk drive and at least one solid-state drive based on the types of the input/output requests to the logical volume,
wherein the reconfigured logical volume occupies a first portion of the at least one solid-state drive and a first portion of the at least one hard disk drive; and
direct the first type of the input/output requests to the first portion of the at least one solid-state drive occupied by the first reconfigured logical volume.

16. The computer readable medium of claim 15, further comprising instructions that direct the storage controller to:
identify an input/output request to another logical volume;
determine that the input/output request to the other logical volume is the second type of the input output requests;
determine that the other logical volume is configured without hard disk drives;
identify a hard disk drive from the plurality of our disk drives to allocate space for the other logical volume; and
direct the input/output request to the hard disk drive with the allocated space for the other logical volume.

17. The computer readable medium of claim 15, further comprising instructions that direct the storage controller to:
analyze storage space of the hard disk drive and of the solid-state drives to identify said at least one of the solid-state drives to direct the first type of the input/output requests to the first reconfigured logical volume.

18. The computer readable medium of claim 15, further comprising instructions that direct the storage controller to:
reconfigure the first logical volume to a homogeneous array of hard disk drives or solid-state drives after configuring the first logical volume from a heterogeneous array of hard disk drives and solid-state drives.

19. The computer readable medium of claim 15, further comprising instructions that direct the storage controller to:
analyze frequency of the smaller input/output requests to configure at least one storage volume from a combination of solid state drives and hard disk drives.

20. The computer readable medium of claim 15, further comprising instructions that direct the storage controller to:
reconfigure another logical volume from at least one of the solid state drives into a combination of solid state drives and hard disk drives.
